(19) United States
(12) Patent Application Publication
(10) Pub. No.: US 2026/0321797 A1
(43) Pub. Date: Oct. 15, 2026

(54) APPARATUS AND METHOD FOR HEATING TRACTION BATTERIES

(71) Applicant: Rainer MARQUARDT, Riemerling (DE)

(72) Inventor: Rainer MARQUARDT, Riemerling (DE)

(21) Appl. No.: 19/168,947

(22) PCT Filed: Mar. 24, 2024
(86) PCT No.: PCT/EP2024/058057

§ 371 Date: Oct. 30, 2025

(30) Foreign Application Priority Data
Mar. 30, 2023 (DE) 10 2023 108 118.7

(51) Int. Cl. H01M 10/6571; H01M 10/42; H01M 10/46; H01M 10/615; H01M 10/625; H02J 7/50; H02M 1/00

(52) U.S. Cl. CPC H01M 10/6571; H01M 10/4264; H01M 10/46; H01M 10/615; H01M 10/625; H01M 2220/20; H02J 7/50; H02J 2207/20; H02M 1/0067

(57) ABSTRACT

A device for heating a drive battery consisting of a plurality of battery cells connected in series, with a converter for feeding a high-frequency alternating current into the drive battery, wherein the converter is connected to a first AC terminal via one or more series capacitors to a first pole of the drive battery, connected to a second pole of the drive battery via one or more series capacitors, connected to the series connection of battery cells, preferably at the center, via a second AC terminal, and connected to a DC source via its DC terminals.

The invention relates to a device and a method for heating drive batteries.

Electrochemical energy storage devices have become key components in many areas of application. In mobile applications—especially in electric vehicles—operation over a wide temperature range is required. Low temperatures generally lead to significant performance limitations in electrochemical energy storage devices. This limits the applicability of both existing cell chemistries and new developments. A current example is the replacement of lithium-cobalt-manganese cells with lithium-iron-phosphate cells, which is limited by their less favorable low-temperature behavior. This problem is known to exist both for the former cells, which are relatively better in this respect, and for the solid-state cells currently under development. In addition to limited power output, fast charging of these batteries is particularly impeded or leads to irreversible damage.

According to the state of the art, the large drive batteries are temperature-controlled by means of external liquid cooling. This effort is necessary because the permissible temperature range of the cells is also narrowly limited in the upper range. In order to use this system for preheating the cells, electrical energy is used to heat the liquid. Most of this energy must be taken from the drive battery itself, which reduces its energy content. There is therefore a desire to reduce the amount of energy required. To a limited extent, this is possible by, among other things, making additional use of the waste heat from the motors or using a heat pump to supply energy from the ambient air. However, in an efficient electric vehicle, there are generally no large heat sources available.

The energy required to preheat a large, heavy drive battery is considerable, and the time constants are also large. The following figures are helpful in illustrating the relevant orders of magnitude: to heat a drive battery weighing 500 kg and with a capacity of 100 kWh (e.g., before charging) by approx. 20° C., approx. 15 kWh are required over a period of approx. 1.5 hours, i.e., an average power of 10 kW. Part of this energy is also required for the coolant itself, as water has a high specific heat capacity.

The disadvantages of this state of the art are therefore the high energy consumption, the time required, and the need for advance planning.

The task of the present invention is therefore to enable the necessary preheating to be carried out in a shorter period of time and with lower energy consumption.

This task is solved by the subjects of the independent claims, with preferred embodiments being the subject of the dependent claims.

The invention is based on the realization that it is advantageous to concentrate the heating as directly as possible on the active part of the battery located inside the cells. This is essentially formed by the surface of the electrodes and the liquid or solid electrolyte. In contrast to heat supply via the outer housing surface of the cells, the relatively high thermal resistance from the active part to the housing surface is helpful in such a solution when heat is supplied from the inside, as it prevents the unwanted dissipation of heat. Furthermore, the thermal time constant of the active part is significantly smaller than that of the entire cell including the housing.

According to the invention, the active part of the cells is heated by high-frequency alternating currents, which are fed into the drive battery in such a way that its proper operation and the operation of the electronic battery management system remain undisturbed.

To this end, the invention proposes devices and a method that make this possible.

In particular, it is proposed that the device be designed to be retrofitted so that it can be connected to any typical drive battery at a later date. However, it is also possible to integrate this device into the battery housing.

In particular, the device is preferably connected to the large number of battery contacts of the internal connections of the cells (which are present in addition to the actual pole contacts) that are already available for measurement purposes in drive batteries, in order to be able to intervene in the inner workings of the batteries from the outside and in a non-invasive manner, so to speak, and to achieve the desired heating specifically there.

The heating is carried out by means of injected high-frequency alternating currents, which preferably do not exert any undesirable interference on the direct current operation of the battery. Preferably, the alternating currents fed in are in opposite phase and have the same amplitude in pairs and preferably cancel each other out completely. As a result, practically nothing is noticeable at the two poles of the battery from the feeding in of the alternating currents.

The device consists of a plurality of battery cells connected in series, with a converter for feeding a high-frequency alternating current into the drive battery, wherein the converter is connected with a first alternating voltage terminal via one or more series capacitors to a first pole of the drive battery, connected to a second pole of the drive battery via one or more series capacitors, connected to a second AC voltage terminal via a second series capacitor, connected to the series connection of battery cells via a second AC voltage terminal, and connected to a DC voltage source via its DC voltage terminals.

In addition to this solution with only one converter and thus a low-cost variant, the upper or first half of the drive battery can be supplied by a first converter and the lower or second half by a second converter. In this case, the respective alternating currents fed in are again preferably antiphase and equal in magnitude, resulting in equal but opposite voltage drops. From the perspective of the two poles of the battery, this means that the alternating currents are not perceived from the outside and do not negatively affect normal operation or battery management. With regard to battery management, it is also advantageous that the supplied alternating currents have a high frequency and therefore any possible interference with measured values can be avoided by means of simple low-pass filters.

The corresponding device consists of a plurality of battery cells connected in series with at least two converters for feeding high-frequency alternating current into the drive battery, wherein a first converter is connected with a first alternating voltage terminal via one or more series capacitors to a first pole of the drive battery, is connected via a second AC terminal, preferably centrally, to the series connection of battery cells, and is connected with its DC terminals to a DC voltage source, wherein a second converter is connected with a first AC terminal via one or more series capacitors to a second pole of the drive battery, is connected via a second AC terminal, preferably centrally, to the series connection of battery cells, and is connected with its DC terminals to a DC source.

The connection of one or both converters should preferably be made centrally.

The capacitors and optional damping resistors used should preferably be of equal value so that the voltage drops resulting from the fed-in currents compensate each other from the perspective of the battery poles.

However, this is not essential if minor AC superimpositions and thus voltage superimpositions are acceptable. This means that central feeding into the drive battery is also not essential if perfect voltage compensation is not required anyway.

In principle, heating is also possible without compensation, i.e., by using a converter that only feeds in alternating current that is not compensated by a corresponding, opposite-phase and preferably equal alternating current fed into another section of the battery from the perspective of the battery poles, provided that the resulting interference is acceptable. However, it should be noted that the impedance of the capacitor of the drive converter typically approaches zero for frequencies above 10 KHz and would therefore short-circuit the HF components perceptible at the poles.

Non-symmetrical division is also possible. For example, instead of dividing the battery into two equal halves and feeding each half with alternating current of equal magnitude but opposite phase to the other half, a division of ⅓ to ⅔, etc. is possible.

The principle according to the invention is not limited to one or two converters. Nor is it limited to the battery being divided into only two halves, with each half being supplied with alternating current in the opposite direction. Instead, the drive battery can be divided into a larger number of N sections, and each of these sections or segments can then be supplied with alternating current by one or two converters. In other words, each section of a given number of battery cells receives alternating current from one or two converters.

Preferably, a segment is supplied with alternating currents from an adjacent pair of converters with opposite phases, so that these cancel each other out from the perspective of the external battery contacts of the respective segment and thus do not cause any interference.

The corresponding heating device for heating a drive battery consisting of a plurality of battery cells connected in series preferably has 2×N converters for feeding high-frequency alternating currents into the drive battery, wherein each of the 2×N converters feeds alternating current into one of N sections of the series connection of battery cells and two converters each feed current in opposite phases to each other, preferably within the same section of the N sections of the drive battery, such that the resulting voltages cancel each other out, each converter is connected via a first AC-side terminal to one of N first voltage points of the series connection of battery cells, and via a second AC-side terminal via at least one capacitor to a respective adjacent voltage point of second N+1 voltage points of the series connection of battery cells, wherein the same number of battery cells is present between each of two adjacent voltage points, and each of the 2×N converters is connected via its DC-side terminals to a DC voltage source.

Preferably, in addition to the capacitors, suitable damping resistors are also installed in the aforementioned different devices in order to counteract possible unwanted oscillations that may arise due to interference frequencies from the drive converter.

The capacitors can preferably be dimensioned so that they compensate for the voltages of the parasitic inductances in the battery circuit for the selected frequency of the alternating current. This corresponds to a resonance tuning, which advantageously reduces the necessary voltage and apparent power of the converter.

The invention also relates to a corresponding method.

Accordingly, a method for heating a drive battery consisting of a plurality of battery cells connected in series is proposed, comprising the following steps: Connecting a converter by means of a first AC-side terminal via a first series connection of a first heating resistor and a first capacitor to a first pole of the drive battery, Connecting the converter by means of the first AC-side terminal via a second series connection of a second heating resistor and a second capacitor to a second pole of the drive battery, Connecting the converter to a second AC terminal, preferably in the middle of the series connection of battery cells, and connecting the converter to a DC source via the DC terminals, and feeding a high-frequency alternating current into the drive battery, wherein the two resulting alternating voltages compensate each other, so that the constant output voltage of the drive battery is not disturbed.

If there are more than two sections fed by 2×N converters, the feed is carried out in the same way as described for the device with 2×N converters.

The invention's method of feeding alternating currents into the interior of the battery in such a way that these alternating currents compensate each other, so that they do not cause interference at the poles of the drive battery, has additional positive effects on the service life of such batteries, in addition to the desired heating or preheating of the battery. Therefore, the device and the method can also be used in normal operation when heating is no longer necessary at all. In this situation, the alternating current then serves chemical purposes to increase the battery life.

The following description provides specific examples of the temperature increase that the proposed solution is capable of achieving using which power.

As a general rule, the internal resistance of the drive battery is significantly higher when cold than when warm, and therefore heating can be performed efficiently, especially when cold. This is more efficient than is possible with coolants or due to the operation of the battery.

Preferably, the devices have a control system that determines from a given battery temperature whether preheating is necessary and, if so, at what power and frequency charging must take place, and adjusts operation accordingly. Operation can be adjusted over time according to the heating success achieved, ensuring energy-efficient heating.

The AC power supplied preferably has a frequency in the range of 16-100 kHz. This range is advantageous because it prevents acoustic interference. At the upper end, it is ensured that the inverter is not subject to excessive demands in terms of its switching frequency and that switching losses can be kept low. The exact choice of frequency depends on the size and geometry of the drive battery. In particular, lower frequencies will be selected for large batteries with large parasitic inductances in order to minimize the load on the converters.

The device may have a radio device so that the heating process can be controlled from a remote location.

The device may have a timer device so that the heating process starts at a predetermined time.

Preferred embodiments are explained in more detail below with reference to the accompanying figures. Shown are:

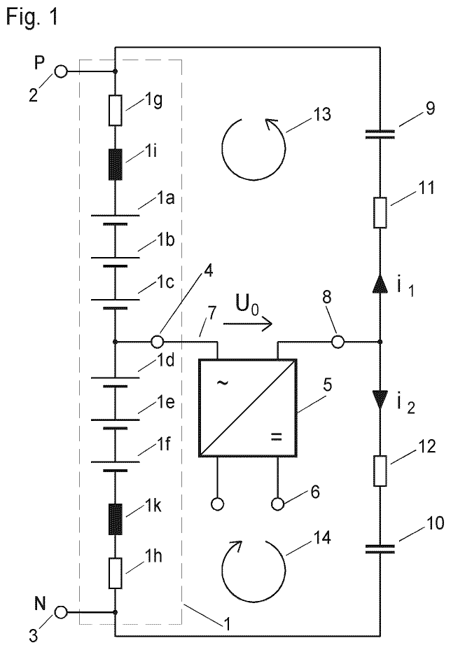

FIG. 1: a schematic representation of a circuit according to one embodiment of the invention,

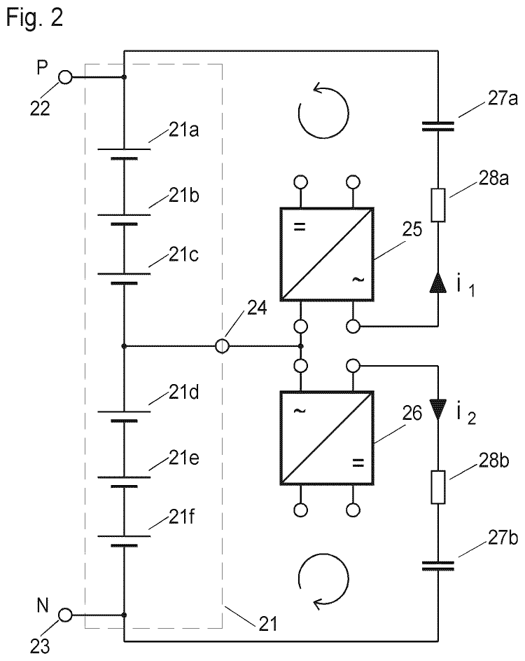

FIG. 2: an alternative embodiment of the invention using two converters, and

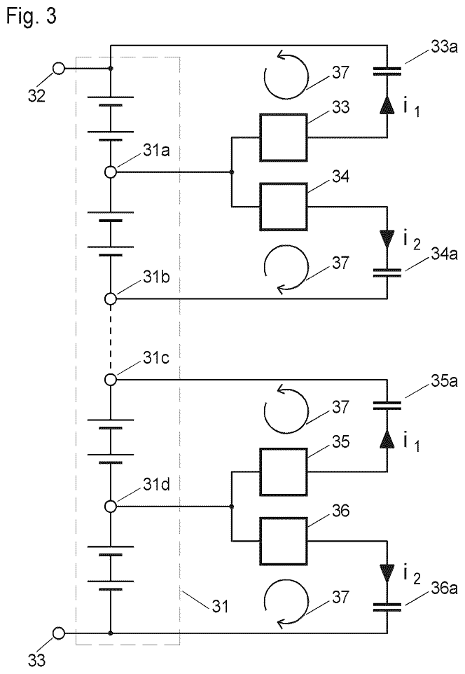

FIG. 3: a schematic representation in general terms for an embodiment with 2×N converters.

FIG. 1 shows a schematically represented drive battery 1 consisting of several battery cells 1a-1f connected in series. A total of 6 cells are shown, but it is clear to the skilled person that this number can be several hundred cells.

The drive battery 1 has a P pole 2 and an N pole 3. Typically, such batteries, especially for measuring purposes, have additional connections located at regular intervals between the battery cells. FIG. 1 shows such a connection 4, at which the center potential of the six battery cells shown can be tapped.

A circuit can be connected to the battery shown in this way, which causes alternating current to be fed into the cells in order to heat the interior of the battery. The corresponding circuit can be retrofitted or switched on as required, or may already be present on the battery.

The circuit has at least one converter 5, which is connected to a DC voltage source (not shown) via its DC voltage side connections 6. The source can also be the drive battery itself, but due to the high voltage of this battery, an additional battery with a low voltage is recommended.

The converter 5 is connected via its AC terminal 7 to the central connection 4 of the drive battery and via its other AC terminal 8 to the P pole of the battery via a capacitor 9 and to the N pole of the drive battery via a capacitor 10. Preferably and optionally, a damping resistor 11, 12 is connected in series to combat unwanted oscillations.

During operation, the converter feeds an alternating current i1 into the upper half of the battery and an alternating current i2 into the lower half. Circuits 13 and 14 illustrate this opposite behavior. With the same dimensions for capacitors 9, 10 and the optional damping resistors 11, 12, it is possible to achieve currents i1 and i2 that are equal in magnitude but opposite in phase. This cancels out these alternating currents in terms of voltage from the perspective of battery poles 2 and 3, and there is no undesirable interference with normal battery operation or battery management.

It is clear to those skilled in the art that capacitors 9, 10 can also be series connections of several capacitors.

In practice, the battery cells 1a-1f may be 100 or more cells, and additional connection points 4 may also be present at regular intervals between an equal number of battery cells.

The feeding in of the alternating currents ultimately causes the battery to heat up internally due to the schematically drawn internal resistance 1f, 1h. Instead of heating the housing or coolant, only the active part of the battery is heated in a targeted manner, thus avoiding unnecessary energy consumption. As discussed below, the internal resistance increases as the temperature falls, which improves the heating performance. This means that the principle according to the invention works best precisely where it is to be used, namely when the battery is cold, in order to quickly increase the useful power of the battery to a solid value by heating it.

Not only are inherent internal resistances 1g, 1 h shown, but also, for the sake of completeness, inductive components 1i, 1k.

FIG. 2 shows, in a manner analogous to FIG. 1, an embodiment which, however, has two converters 25, 26. Each of the two converters is supplied by a DC source via its DC-side terminals. On the AC side, one terminal of each converter is connected to the central battery connection 24.

The second AC-side terminal of converter 25 is connected to the P-pole 22 of the drive battery 21 via a capacitor 27a (or a series connection of capacitors). Similarly, the other AC-side terminal of the inverter 26 is connected via a capacitor 27b (or a series connection of capacitors) to the N-pole 23 of the drive battery 21, which in turn consists of a plurality of battery cells 21a-f connected in series with each other. Optionally, damping resistors 28a, 28b may again be provided, as well as a switch 29 for selectively connecting the branches connected to the battery poles.

FIG. 3 generalizes the embodiments in the direction of 2×N converters. With an even number of 2×N converters, one of N sections of the battery 31 can be supplied with alternating current by two converters at a time. Two converters always feed into one of the N sections, wherein this occurs in two halves of a section in each case. This enables the battery to be heated section by section.

The drive battery 31 can thus be divided into, for example, 20 sections. The compensating behavior of adjacent converters can be seen from the circles 37 drawn in the diagram. The converters 33, 34, 35, 36 are only shown schematically and are examples; in reality, a significantly larger number of converters can be used. It can be seen that pairs 33, 34 and 35, 36 of converters with an AC connection are connected together at a connection point 31a, 31d. With their respective second connection, each converter in a pair is connected to the next connection point of the drive battery via a capacitor 33a, 34a, 35a, 36a, as shown in FIG. 3. Converter 33 is thus connected via capacitor 33a to the outermost connection, i.e., battery terminal 32, to span a certain number of battery cells, in the example 2 cells. Accordingly, converter 34 is connected via capacitor to the next connection 31b and spans the same number of battery cells. The 4 cells shown thus form a section of the battery that can be heated specifically via two converters. The same applies to converters 35, 36 and capacitors 35a, 36a, as well as to all other converters not shown.

FIG. 3 is only schematic. Of course, all converters are supplied with energy from energy sources on their DC voltage side. Additional damping resistors analogous to FIG. 1 and FIG. 2 are possible, as are switches as in FIG. 2, which can connect the return branches of each converter pair or even converter pairs to each other.

Overall, it is preferable to ensure that all fed-in alternating currents cancel each other out, at least from the perspective of the main poles 23 and 33, so that normal battery operation is not disrupted. This means that the currents should be in opposite phase and equal in magnitude in pairs. However, currents from converters that are not located directly next to each other can also compensate each other.

It is apparent to the skilled person that all embodiments follow the same basic idea and that details of one embodiment can therefore also be applied to the other embodiments.

A quantitative estimate of the heating achievable by means of the invention can be made on the basis of known, typical data for the fast charging of drive batteries, because here too, current-induced internal heating occurs. In contrast to the invention, however, this involves direct current:

When fast charging the above-mentioned battery with P_{charge}=4·P_{drive}=400 kW, which is permissible for a high-quality battery according to the state of the art, a current of 800 A and an internal “heating power” of P_{Vcharge}=(800 A)²·0.0050=32 kW will occur.

If this charge is applied to a battery with an initial temperature of Vₐ=25° C., the battery generally reaches an internal temperature of approx. 60° C. after approx. 15 minutes, meaning that the charging current must be reduced. The temperature gradient is therefore approx. 35 km/15 min≈2.3° C. per minute. Because the thermal time constant of such a large battery is greater than one hour, the internally generated heat cannot be dissipated to any significant extent during the above-mentioned period. It is therefore possible and useful to compare the adiabatic temperature gradient for estimation purposes. Furthermore, it should be assumed that, in order to protect the battery, the relative overvoltage during charging is not higher than during the above-mentioned fast charging. Whether this conservative boundary condition should be adhered to depends on the specific technology of the battery and is not universally applicable.

The battery will generally only be heated if its internal resistance is significantly increased—e.g., already at least twice the above-mentioned nominal value of R_{I}=0.050. Under these starting conditions, a heating alternating current of 400 A will be applied in accordance with the above-mentioned conservative current limitation. The internal power that heats the active part of the battery will therefore be

$${P}_{VHeating} = {( 400 A )}^{2} \cdot 0.1 Ω = 16 kW$$

The temperature gradient will therefore be (2.3 k/min)·, i.e. approx. 1.65° C. per minute. This value is significantly higher than the values achievable by external heating of the battery. This leads to significantly reduced energy requirements and reduced, more predictable preheating times.

In order to achieve significant heating during driving—due to the electricity required for the drive—very high battery outputs would be necessary, as the following further comparison shows. Driving with P_{drive}=100 kW, which would not be achievable even when driving continuously at v=200 km/h on the highway, leads to an internal power loss of

$${P}_{v} = {( 200 A )}^{2} \cdot 0.1 Ω = 4 kW$$

i.e., a temperature gradient of approx. 0.3° C. per minute. With realistic driving, e.g., P_{drive}≤33 kW on the highway (at a recommended speed of v=130 km/h), the temperature gradient would already be negligible at approx. 0.046° C. per minute.

A significant advantage of the invention lies in the fact that a usable heating of the battery can be achieved in a short period of time compared to the thermal time constant of the battery. In this range of adiabatic heating, no significant energy is lost through heat dissipation in the housing, cooling circuit, and environment.

1. Device for heating a drive battery consisting of a plurality of battery cells connected in series, comprising:
a converter for feeding a high-frequency alternating current into the drive battery,
wherein the converter
is connected with a first AC-side terminal via one or more series capacitors to a first pole of the drive battery,
is connected with the first AC-side terminal via one or more series capacitors to a second pole of the drive battery,
is connected via a second AC terminal, preferably centrally, to the series connection of battery cells, and
is connected with its DC terminals to a DC source.

2. Device for heating a drive battery consisting of a plurality of battery cells connected in series, comprising:
at least two converters for feeding a high-frequency alternating current into the drive battery,
wherein a first converter
is connected with a first AC-side terminal via one or more series capacitors to a first pole of the drive battery,
is connected via a second AC terminal, preferably centrally, to the series connection of battery cells, and
is connected with its DC terminals to a DC voltage source,
wherein a second converter
is connected with a first AC terminal via one or more series capacitors to a second pole of the drive battery,
is connected via a second AC-side terminal, preferably centrally, to the series connection of battery cells, and
is connected with its DC-side terminals to a DC voltage source.

3. Device for heating a drive battery consisting of a plurality of battery cells connected in series, comprising:
2×N converters for feeding high-frequency alternating currents into the drive battery,
wherein each of the 2×N converters feeds alternating current into one of N sections of the series connection of battery cells and
in each case 2 converters feed current in antiphase to each other, preferably within the same section of the N sections of the drive battery, in such a way that the voltage drops of all cells caused by the high-frequency alternating currents cancel each other out,
each converter is connected via a first AC-side terminal to one of N first voltage points of the series connection of battery cells, and is connected via a second AC-side terminal via at least one capacitor to a respective adjacent voltage point of second N+1 voltage points of the series connection of battery cells, wherein the same number of battery cells is present between two adjacent voltage points, and
each of the 2×N converters is connected with its DC voltage side terminals to a DC voltage source.

4. Device according to one of the preceding claims, wherein the fed-in alternating currents are equal in magnitude but opposite in phase, such that no high-frequency components arise at the battery poles.

5. Device according to one of the preceding claims, wherein damping resistors are connected in series with the capacitors.

6. Device according to one of the preceding claims, wherein all capacitors have the same values.

7. Device according to one of the preceding claims, wherein the alternating currents have frequencies in the range of 16-100 KHz.

8. Device according to one of the preceding claims, wherein the circuit is integrated into the battery housing.

9. Device according to one of the preceding claims, wherein the converter has a transformer on the DC voltage side so that it can be powered by the drive battery.

10. Device according to one of claims 2-9, wherein several converters are formed by a single converter with a transformer with several potential-separated output windings, wherein several output alternating voltages can be generated by the potential-separated output windings.

11. Method for heating a drive battery consisting of a plurality of battery cells connected in series, comprising the following steps:
connecting a converter by means of a first AC-side terminal via one or more capacitors to a first pole of the drive battery,
connecting the converter by means of the first AC-side terminal via one or more capacitors to a second pole of the drive battery,
connecting the converter to a second AC terminal, preferably centrally, with the series connection of battery cells, and
connecting the converter to a DC source via the DC terminals, and
feeding high-frequency alternating currents into the drive battery.
